(19) United States
(12) Patent Application Publication
(10) Pub. No.: US 2012/0260263 A1
(43) Pub. Date: Oct. 11, 2012

(54) METHOD, SYSTEM AND PROGRAM FOR DATA DELIVERING USING CHATBOT

(75) Inventor: David Edoja, Barnet (GB)

(73) Assignee: Analytics Intelligence Limited, Barnet (GB)

(21) Appl. No.: 13/084,445

(22) Filed: Apr. 11, 2011

(51) Int. Cl. G06F 9/54

(52) U.S. Cl. 719/313

(57) ABSTRACT

A computer-implemented method, system and program for interactive data delivering are described. A method for the interactive data delivering provides an effective way for retrieving, analyzing, processing and presenting business analytics data to a user in a natural, conversational way. The method may comprise receiving a request from the user to provide the analytics data in the natural language format, converting the command in the natural language format into one or more Application Programming Interface (API) calls, retrieving generic data associated with the request of the user based on the API calls, generating a semantic model associated with the generic data and the user request, processing the retrieved generic data to generate analytics data, with the processing being based on the semantic model, communicating the analytics data to a chatbot, and converting, under control of the chatbot, the analytics data into a natural language format for delivering to the user.

### TECHNICAL FIELD

This disclosure relates generally to artificial intelligence dialog systems and, more specifically, to the processing and interactive data reporting using a chatbot.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Traditionally, business analytics has been used for analysis of business performance. Business analytics may assist business owners or managers in gaining insight, business planning and understanding of business performance. Generally, business analytics data is based on statistical data and methods of their arrangements. Business analytics data can help to answer questions such as what happened, how often, where the problem is, and what actions are needed to be taken. Business analytics can also answer questions like why is this happening, what if happens if the current trends continue, what will happen next, and how to optimize the performance.

Business analytics may refer to website analytics, sales analytics, financial services analytics, risk & credit analytics, marketing analytics, fraud analytics, pricing analytics, legal analytics, medical analytics, IT analytics, transportation analytics, customer relationship management (CRM) analytics, competitive intelligence analytics, and so forth. In other words, business analytics data may relate to multiple different areas, and generally require special knowledge and skills to understand and manipulate such data.

Today's business market is saturated with business analytics data from online sources, CRM tools, web analytics tools, business intelligence sources, market intelligence sources, and so forth. The majority of business analytics tools available today for business owners are visualization tools. Such tools provide users with statistic data, graphs, charts, tables, and so forth that may be hard to understand for many business owners. In many instances, business owners or managers may find it difficult to correctly understand bulky statistic data and so may not take appropriate steps to address business relative issues such as sales issues, marketing issues, website optimization (search engine optimization) issues, CRM issues, legal issues, and so forth.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In accordance with various embodiments, interactive data delivering is disclosed herein, which provides an effective way for retrieving, analyzing, processing and presenting business analytics data to a user in a natural, conversational way. The data delivery can be performed via a Virtual Analyst Platform, which includes a Virtual Analyst Interface and an Analytics Intelligence Engine.

In one embodiment, a computer-implemented method for interactive data delivery is provided. The method may comprise retrieving generic data associated with a request of a user, generating a semantic model associated with the generic data and the request, processing the retrieved generic data to generate analytics data, wherein the processing is based on the semantic model, communicating the analytics data to a chatbot, and converting, under control of the chatbot, the analytics data into a natural language format for delivery to the user.

In one example, the method may further comprise receiving a command from the user for providing the analytics data in a natural language format and converting the command in the natural language format into one or more Application Programming Interface (API) calls. The retrieving of the generic data may be implemented in response to the one or more API calls. The converting of the command into the natural language format may comprise parsing the command in the natural language format, determining an input-response dialogue pair, and generating the one or more API calls associated with the input-response dialogue pair.

In yet another example, the method may further comprise retrieving service data associated with the user in response to the one or more API calls. The processing of the website statistics data may comprise one or more of the following: comparing the retrieved generic data to benchmark data, segmenting the retrieved generic data, evaluating metrics for the segments of the generic data, and generating the analytics data. The processing may further comprise applying rules of the semantic model against the generic data, the rules being associated with the user request. The processing of the website statistics data may be associated with the one or more API calls.

In yet another example, the method may further comprise merging the analytics data with a template response associated with the input-response dialogue pair. In yet another example, the method may further comprise delivering the analytics data in the natural language format to the user via a user interface. The analytics data to be delivered to the user may further be provided with one or more of the following: text information, visual information, and a link to external source. The input provided in a natural language format may be text input or voice input.

According to one embodiment, a system for interactive data delivering is provided. The system comprises one or more processors configured to retrieve generic data associated with a request of a user, generate a semantic model associated with the generic data and the user request, process the retrieved generic data to generate analytics data, the processing is based on the semantic model, communicate the analytics data to a chatbot, and convert, under control of the chatbot, the analytics data into the natural language format for delivering to a user. The system may also comprise a memory coupled to the one or more processors storing computer-executable instructions.

In one example, the one or more processors may further be configured to receive a command from the user to provide the analytics data in a natural language format, and convert the command in the natural language format into one or more API calls. The one or more processors may retrieve generic data in response to the one or more API calls. The one or more processors may be configured to convert the command in the natural language format as implemented by parsing the command in the natural language format, determining an input-response dialogue pair, and generating the one or more API calls associated with the input-response dialogue pair.

In yet another example, the one or more processors may be further configured to retrieve service data associated with the user in response to the one or more API calls. The one or more processors may be configured to process the generic data based on the one or more API calls. The one or more processors may further be configured to merge the analytics data with a template response associated with the input-response dialogue pair. The one or more processors may further be configured to deliver the analytics data in the natural language format to the user via a user interface. The one or more processors may be configured to process the generic data by applying rules of the semantic model against the generic data, with the rules are associated with the user request.

According to one embodiment, a computer-readable medium comprising instructions is provided. When instructions are executed by one or more computers, they cause the one or more computers to perform the following operations: retrieve generic data associated with a request of a user, generate a semantic model associated with the generic data and the user request, process the retrieved generic data to generate analytics data, the processing is based on the semantic model, communicate the analytics data to a chatbot, and convert, under control of the chatbot, the analytics data into the natural language format for delivering to a user.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 is a computing environment, within which a Virtual Analyst Platform can be implemented, in accordance with one example embodiment.

FIG. 2 is a block diagram illustrating the Virtual Analyst Platform, in accordance with an example embodiment.

FIG. 3 is a process flow diagram illustrating a method for interactive data delivery, in accordance with an example embodiment.

FIG. 4 is a process flow diagram illustrating a further method for interactive data delivery, in accordance with an example embodiment.

FIG. 5 is a Virtual Analyst chat interface, according to an example embodiment.

FIG. 6 is a diagrammatic representation of an example machine in the form of a computer system within which a set of instructions, for causing the machine to perform any one or more of the methodologies discussed herein, are executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The embodiments described herein can be implemented by various means depending upon the application. For example, embodiments can be implemented in hardware, firmware, software, or a combination thereof. For a hardware implementation, embodiments can be implemented with processors, controllers, micro-controllers, microprocessors, electronic devices, other electronic units designed to perform the functions described herein, or a combination thereof. Memory can be implemented within the processor or external to the processor. As used herein, the term “memory” refers to any type of long term, short term, volatile, nonvolatile, or other storage device and is not to be limited to any particular type of memory or number of memories, or type of media upon which memory is stored. For a firmware and/or software implementation, embodiments can be implemented with modules such as procedures, functions, and so on, that perform the functions described herein. Any machine readable medium tangibly embodying instructions can be used in implementing the embodiments described herein.

Embodiments disclosed herein relate to artificial intelligence dialog systems for interactive data delivery using a chatbot. A dialog system, as used herein, is a computer system intended to provide customer service or other assistance via a website by receiving a user request in a natural language format, converting the request into a machine-readable form, processing the request, and responding to the request by delivering requested information in a natural language format.

According to embodiments disclosed herein, data to be delivered via a dialog system may relate to multiple business fields such as website analytics data, sales analytics data, CRM data, business intelligence data, competitive intelligence data, financial services analytics, risk and credit analytics, marketing analytics, fraud analytics, pricing analytics, legal analytics, medical analytics, IT analytics, transportation analytics, and so forth.

Below is provided an embodiment related to delivery of web analytics data. Although this embodiment is directed to web analytics data, it shall not be understood as a limitation, and those skilled in the art would understand that any possible data can be used.

Website analytics is generally used for the measurement, collection, analysis, and reporting of website usage data and website visitor behaviors for the purpose of understanding and optimizing website usage. Website analytics can measure and analyze performance of a website in commercial as well as noncommercial contexts. In a commercial context, a website owner may want to know which pages of the website encourage people to make a purchase. The data collected during performance measurements of the website can be used to improve website effectiveness.

In website analytics, various approaches can be taken to collect and process data related to website performance. According to one approach, log files in which the web server records its transactions can be read and analyzed. In another approach, pages of the website can be tagged with a snippet of computer code (e.g., JavaScript or an image) to notify a third-party server when the pages are rendered by the web browser. The snippet can also pass certain information about the webpage and the visitor to the third-party server. This information can then be processed and appropriate statistics generated. The statistics can then be used to provide reports, which can include website performance information, number of page views, time of the day, cursor movement data, and click data (e.g., location on the page, object clicked on, and other custom metrics). In order to uniquely identify a user during multiple visits, the user can be assigned a cookie.

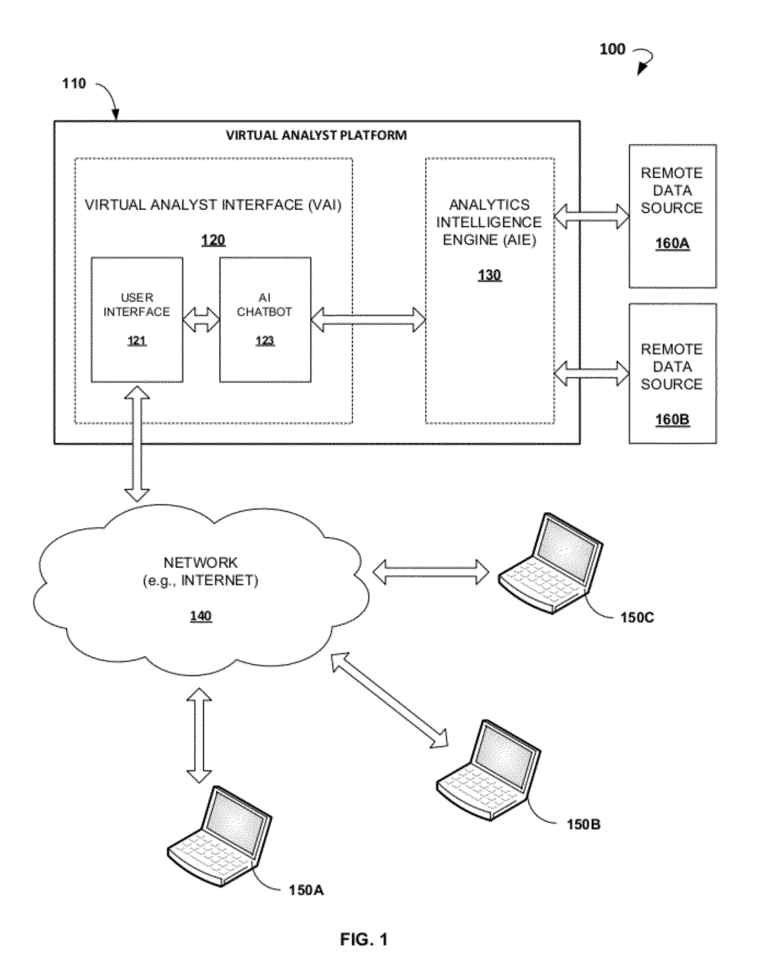

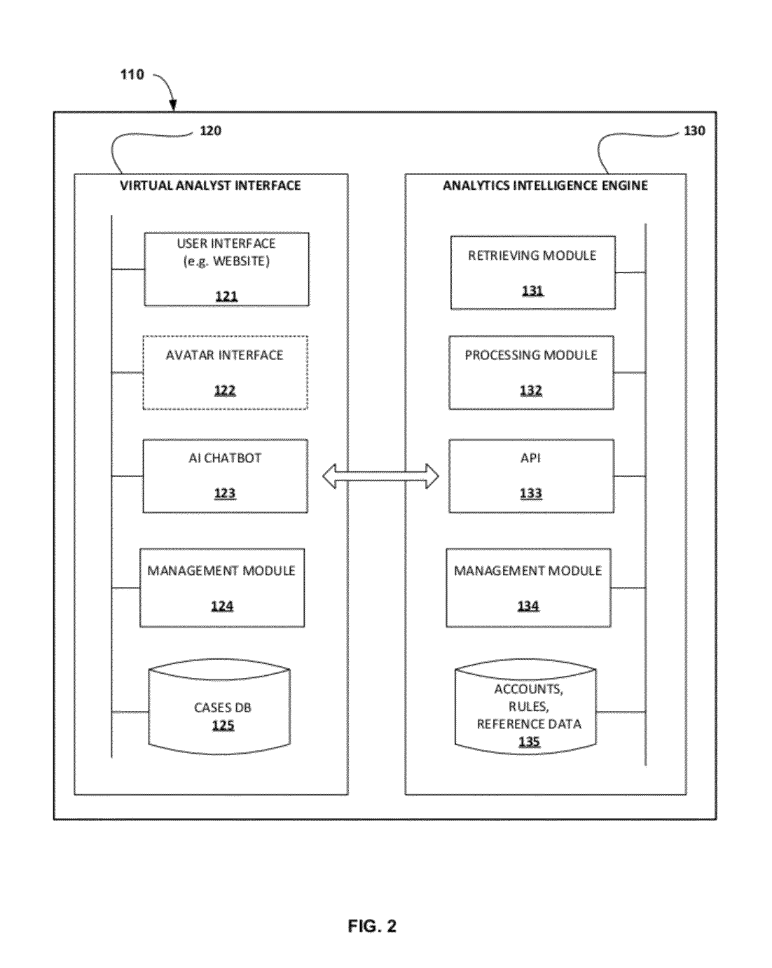

Referring now to the drawings, FIG. 1 illustrates an example of computing environment 100, within which a Virtual Analyst Platform can be implemented. The Virtual Analyst Platform can be considered as an integrated web platform (application) 110 configured to access, process, and communicate data such as web statistics data, web analytics data, CRM data, business intelligence data, competitive intelligence data and any other form of business data. The web platform 110 can be embedded into one or more web servers, and may include a Virtual Analyst Interface (VAI) 120 and an Analytics Intelligence Engine (AIE) 130, which will be described in detail below with reference to FIG. 2. The web platform 110 can be accessed by users via a network 140, such as the Internet.

The embodiment shown in FIG. 1 can be implemented in a client-server environment. The Internet is one example of a client-server environment. However, any other appropriate type of client-server environment, such as an intranet, a wireless network, a telephone network, a cellular network, and the like, or a combination thereof, may also be used. This disclosure, however, is not limited to the client-server model and could be implemented using any other appropriate model.

The users may access the web platform 110 via terminals 150A, 150B, and 150C. As used herein, the term “terminal” refers to a computer, a mobile device, a handheld cellular phone, a smart phone, user equipment, a portable communication device, a portable computing device, a personal digital assistant (PDA), a tablet personal computer, or some other electronic device with the ability to receive and transmit data via a wired or wireless network. In some embodiments, the terminals 150A-150C may be provided with the ability to browse and/or interact with websites on the Internet, thereby allowing users to communicate with the web platform 110. In some embodiments, the terminals 150A-150C may embed proprietary software for communicating with the web platform 110. For example, the terminals may embed software for communicating in the way of real-time direct text-based communication (such as Instant Messaging, chats), audio/video based communication, telephone messages, e-mails, and so forth.

The VAI 120, as a part of the virtual analyst platform 110, may be provided with a user interface 121 configured to provide communication with users. In some embodiments, the user interface 121 is a website that can be accessed via the Internet. According to other embodiments, the user interface 121 may be implemented as a software for communicating data with user terminals 150A-150C in the way of instant messages (IM), telephone messages (e.g. SMS, MMS), e-mails, blog postings, social media messages such as tweets, and so forth.

According to various embodiments disclosed herein, the Virtual Analyst Interface 120 comprises an Artificial Intelligence (AI) chatbot 123. As used herein, the term “chatbot” refers to a computer program configured to simulate an intelligent conversation with users via voice, images, video and/or text on an instant message basis. Such programs are sometimes referred to as Artificial Conversational Entities, talk bots or chatterbots. In other words, chatbots may provide users with text-to-speech and speech recognition functions such that users may interact with a chatbot similarly as in communication with a real person. The chatbot may therefore recognize a user's speech, convert it into machine-readable form, process user requests, and deliver corresponding responses as spoken language. According to another embodiment, the chatbot may receive alphanumerical user input instead of using a speech recognition function. Studies performed have shown that people process information better and avoid misinterpretations if the information is presented via the chatbot. The AI chatbot 123 is described in more details below with reference to FIG. 2.

The AIE 130 is a part of the Virtual Analyst Platform 110, and a computer program or application, which may be used for retrieving and processing data such as web statistics data. Web statistics data may be retrieved from remote data sources 160A, 160B. Although there are two remote data sources 160A, 160B shown in FIG. 1, for those who are skilled in the art, it is understandable that any number of such sources can be accessed by the web portal 110. According to an example embodiment, the remote data source 160A or 160B is a remote web statistic system such as Google Analytics®, Site Catalyst®, WebTrends®, GoodData®, NetStats®, or the like. According to another example embodiment, the remote data source 160A or 160B is an Internet-based search engine such as Google®, Yahoo®, Bing®, and the like. Those who are skilled in the art would understand that any remote data source, public or private, can be used. The Analytics Intelligence Engine (AIE) 130 may communicate with the remote data source 160A, 160B directly (as shown), or via the network 140.

As used herein, the term “web statistics data” refers to a number of visits, hits, amount of received/transmitted data, number of viewed pages, session duration, active time, engagement time, number of unique visitors/new visitors/repeated visitors, number of errors, exit percentage, page depth, page viewers per session, clicks, click path, heat mapping, and the like. Web statistic data can be gathered by web statistic systems 160A, 160B using any known methods, such as log file analysis, page tagging or other methods.

FIG. 2 is a block diagram illustrating the Virtual Analyst Platform 110. As mentioned, the Virtual Analyst Platform 110 includes the Virtual Analyst Interface (VAI) 120 and the Analytics Intelligence Engine (AIE) 130. In one example embodiment, the VAI 120 may include the user interface 121, which can be implemented as a website, or software configured to interact with a user. The user interface 121 may receive a user's input in alphanumerical form, speech form, or mouse clicks, and may deliver data to the user via visual, audio (voice), and/or text form.

In one embodiment, the VAI 120 may optionally comprise an avatar interface 122 for simulating the appearance of a person delivering the speech. According to one embodiment, an avatar engine is remotely located, while the VAI 120 is provided with an application (the avatar interface 122) for accessing or generating a corresponding avatar representation. According to another embodiment, the avatar interface 122 embedded in the VAI 120 may serve as the avatar engine for accessing and generating a corresponding avatar representation. In example embodiments, an avatar appearance can be selected by a user before requesting that the web platform report analytics data. The user may also select different avatars for delivering different types of analytics data.

The VAI 120 further includes the AI chatbot 123 serving to convert and process received user input into machine-readable form. In one embodiment, the AI chatbot 123 receives a user's text or speech command in the natural language format and parses this command. For this purpose, the AI chatbot 123 may comprise (or access a remotely located system) a speech recognition system (not shown). For example, the user may give a command in the way of saying “Okay,” “Go ahead,” “Continue” or the like to order the Virtual Analyst Platform 110 to execute a corresponding action. Such commands can be recognized by the AI chatbot 123, and all of these commands should be interpreted in a single form.

In one another embodiment, the user may input an alphanumerical command to be parsed by the AI chatbot 123. In yet another embodiment, the user may press/click buttons, click targets/links, or the like, which are provided to the user to instruct the web platform to deliver a specific data.

According to an example embodiment, the chatbot engine may be remotely located, and the VAI 120 may possess a corresponding application to address the remote chatbot engine. Otherwise, the VAI 120 may comprise the chatbot engine to perform the functions described herein.

The VAI 120 may also include a management module 124 configured to manage the user interface 121, the avatar interface 122 (if any), the AI chatbot 123 and a cases database 125. The management module 124 may comprise rules for treating user requests/commands, retrieving, analyzing and delivering data, identifying and selecting cases, merging responses, and the like.

When the AI chatbot 123 semantically recognizes the user's command, the management module 124 proceeds to identify the best matching “case” (an input-response dialogue pair). The cases can be stored in the cases database 125. Multiple different cases can be provided to address multiple needs for delivering information to the users. Each case is provided with one or more template responses. For example, if the user's command is interpreted as “number of visits for today” related to the user's website, the case may have a template response “The number of visits is . . . ” This response is then accomplished with corresponding data retrieved from the AIE 130, as will be described below. Thereafter, the response is reported to the user via the user interface 121 using the avatar simulation speech, text or image/video output, or the like. In some embodiments, the response output may comprise links to external sources of information (e.g. texts, images, graphs, tables, videos, audios, links, and so forth).

To retrieve data from the AIE 130 the AI chatbot 123 generates and communicates one or more API calls to the AIE 130 in accordance with an identified case. The AIE 130 processes the API calls of the AI chatbot 123 and returns a corresponding response. This response can then be merged with the case template response and delivered to the user.

The Analytics Intelligence Engine (AIE) 130 is a core artificial intelligence driven analytics system. The AIE 130 comprises a retrieving module 131 configured to access remote data sources, such as sources 160A, 160B shown in FIG. 1 (e.g. remote web statistic systems), and retrieve corresponding data from them. The retrieving module 131 is configured to access APIs of remote data sources to retrieve corresponding data. The retrieved data may be optionally stored in the database 135 for further use.

The AIE 130 may also comprise a processing module 132. The processing module 132 is configured to generate a semantic model and process generic data retrieved by the retrieving module 131 and generate analytics data (e.g. web analytics data) according to multiple rules and reference data stored in the database 135. The processing of generic data (e.g. web statistic data) relative to a request of the user may include a comparison of the retrieved generic data to benchmark data, segmentation of the retrieved generic data, evaluation of metrics for the segments of the generic data, and subsequent generation of the analytics data (e.g. website analytics data).

In one example related to web analytics, segmentation derived from the web statistics data may involve a number of viewed pages, number of hits, a bandwidth, files downloaded, IP geo locations, Visit/Visitor/Page referrer, new vs. returning visitor, paid vs. organic search referred, visitor frequency, buyers vs. non-buyers, new vs. repeated buyers, purchase frequency, screen resolution, browser type, operating system type, marketing campaigns seen, or alike.

According to one example, the semantic model generated by the processing module 132 may be associated with the generic data and include concepts retrieved from the remote data sources and an ontology (relationship and history of the concepts). The semantic model may also be associated with the user request, and specifically with an input-response dialogue pair. The semantic data may also be associated with a set of rules stored in the database 135. The set of rules can be selected based on specific concepts, an ontology, or input-response dialogue pair to address specific request of the user relative to the user's objectives, goals and reporting requirements. Accordingly, the retrieved generic data is processed by the processing module 132 against a set of rules selected by the semantic model.

Thus, processing of the generic data and generating analytics data is conducted according to a specific command of the user with reference to rules stored in the database 135.

The AIE 130 further comprises an API 133 configured to receive API calls from the AI chatbot 123 and instruct the modules of AIE 130 to conduct a corresponding action. In one example, received API calls are converted into the codes accessible by specific implementation of the AIE 130 (for example, into XML codes, Perl codes, C# codes, .NET codes, etc.) and transmitted to a management module 134. The management module 134 is configured to manage all modules comprised in the AIE 130. In particular, upon receipt of the command from the API 133 associated with API calls, in turn, received from the VAI 120, the management module 134 may retrieve a corresponding rule set and service data (such as user account data, reference data, etc.) from the database 135 to request the retrieving module to retrieve corresponding data, to generate a semantic model, and to process data according to the selected rule set and the semantic model. Processed data (i.e. analytics data, such as web analytics data) is then returned to API 133 to communicate to the VAI 120 via the AI chatbot 123.

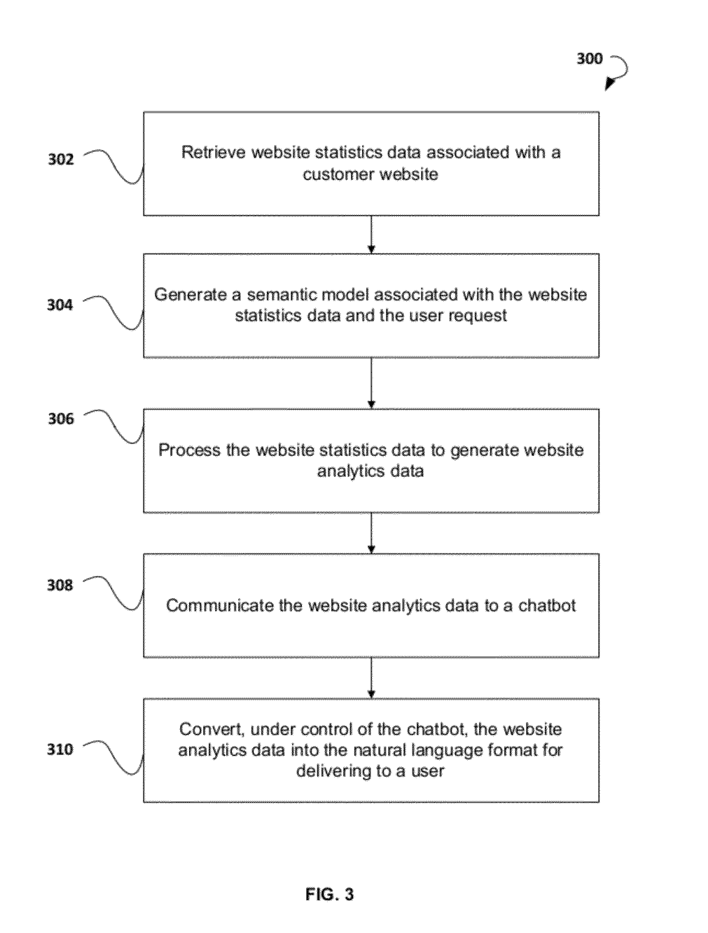

FIG. 3 is a process flow diagram illustrating a method 300 for the interactive delivering of website analytics data, in accordance with an example embodiment. The method 300 can be performed by processing logic that can comprise hardware (e.g., dedicated logic, programmable logic, and microcode), software (such as software run on a general-purpose computer system or a dedicated machine), or a combination of both. In one example embodiment, the processing logic resides at the web platform 110, illustrated in FIG. 1. The method 300 can be performed by the various modules discussed above with reference to FIG. 2. Each of these modules can comprise processing logic.

As shown in FIG. 3, the method 300 can commence at operation 302 with the AIE 130 retrieving generic data such as web statistic data related to the usage of a customer website. As mentioned, the website statistics data can be retrieved by the retrieving module 131 directly from a remote web statistic system or via a network.

In operation 304, the AIE 130, and in particular the processing module 132 or, alternatively, the management module 134, generates a semantic model associated with the generic data and the user request related to the website usage

In operation 306, the AIE 130, and in particular the processing module 132, processes the website statistics data to generate website analytics data. The processing may include a comparison of the retrieved website statistics data to benchmark data, segmentation of the retrieved website statistics data, evaluation of metrics for the segments of the website statistics data, and generation of the corresponding analytics data. The processing may also include applying rules against the website statistics data, the rules are selected from the database 135 and associated with the semantic model.

In operation 308, the website analytics data is communicated to the VAI 120 via the AI chatbot 123. Such communication is performed at the API level. In operation 310, the AI chatbot 123 converts the website analytics data into a natural language format for delivering to the user.

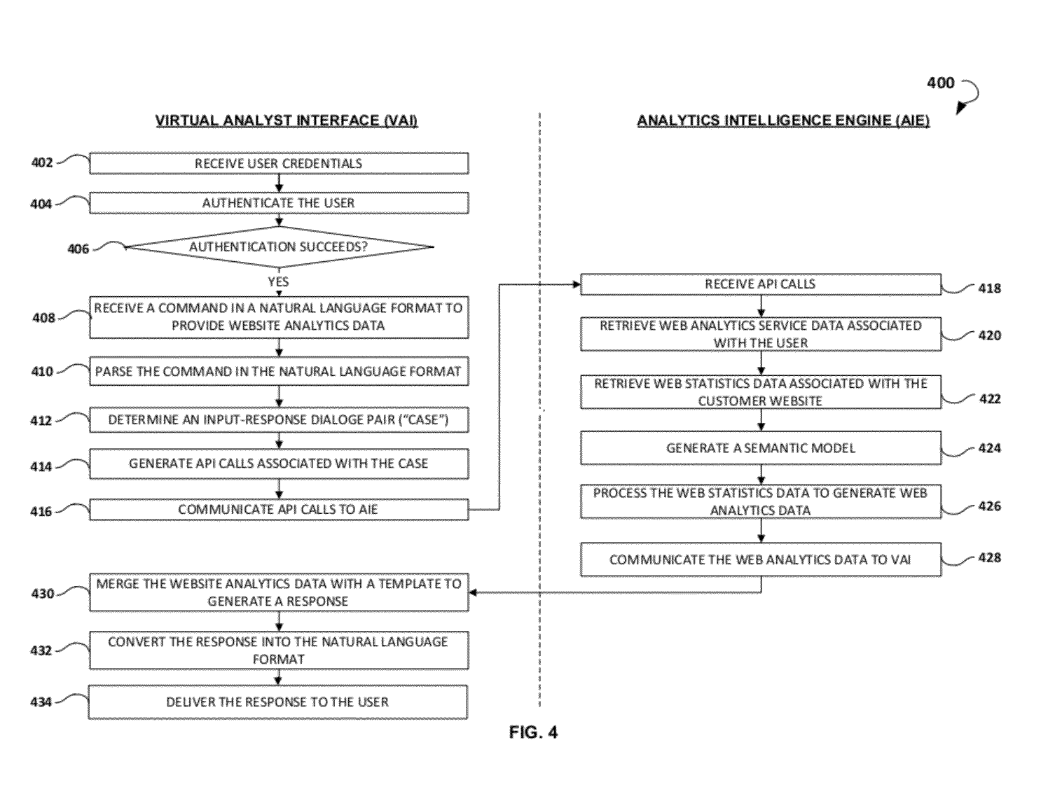

FIG. 4 is a process flow diagram illustrating a further method 400 for the interactive delivering of website analytics data, in accordance with an example embodiment. Although FIG. 4 shows the delivery of website analytics data, those skilled in the art would understand that any other business analytics data can be delivered. The method 400 can be performed by processing logic that can comprise hardware (e.g., dedicated logic, programmable logic, and microcode), software (such as software run on a general-purpose computer system or a dedicated machine), or a combination of both. In one example embodiment, the processing logic resides at the web platform 110, illustrated in FIG. 1. The method 400 can be performed by the various modules discussed above with reference to FIG. 2. Each of these modules can comprise processing logic.

As shown in FIG. 4, the method 400 may commence at operation 402, when the VAI 120 receives user credentials. The VAI 120 can then authenticate the user credentials at operation 404. At operation 406, it can be determined whether the user is a valid customer associated with a customer website to be analyzed. If the VAI 120 cannot authenticate the user as a valid customer, the process may be aborted. If, on the other hand, the user is authenticated as the customer, the VAI 120 proceeds to operation 408, at which a user command in a natural language format is received. The command can be a voice or text based command received via the user interface 121. The user command is associated with the need to provide website analytics data.

In operation 410, the AI chatbot 123 parses the command in the natural language format and generates a machine-readable corresponding equivalent. At operation 412, the management module 124 (or the AI chatbot 123) determines a case (an input-response dialogue pair) associated with the received command.

In operation 414, the AI chatbot 123 generates one or more API calls associated with the case, and, at operation 416, the API calls are communicated to the AIE 130.

In operation 418, API calls are received by the API 133 of the AIE 130, and may optionally be converted in another software code understandable within the AIE 130. Based on the received API calls, at operation 420, the management module 134 retrieves website analytics service data (such as account data (company size, industry sector, geography, preferences, settings, and other configurations) and/or corresponding rules for further data processing). At the next operation 422, the management module 134 requests that the retrieving module 131 retrieve website statistics data from a corresponding remote system or service.

In operation 424, the processing module 132 generates a semantic model based on the case and retrieved website statistics data. The semantic model may comprise concepts, an ontology, and may define a specific set of rules for further processing of the website statistics data to generate analytics data addressing specific needs of the user in accordance with the user's preferences.

In operation 426, the processing module 132 processes the retrieved website statistics data to generate website analytics data (as described above). The processing may be based on applying the rules defined by the semantic model. The website analytics data is then communicated to the VAI 120 at operation 428. Such communication is conducted via the API 133 and the AI chatbot 123.

Upon receiving of the website analytics data by the AI chatbot 123, the management module 124 at the next operation 430 merges the website analytics data with a template to generate a response to the user. The template is associated with the case determined in operation 412.

In operation 432, the response is converted into the natural language format by the AI chatbot 123. At operation 434, the response is delivered to the user via the user interface 121 in the audio, video, image or text form.

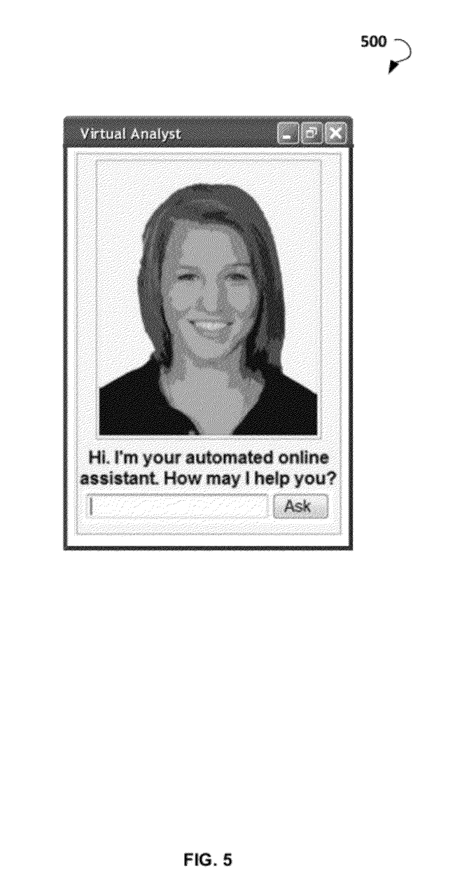

FIG. 5 illustrates a user interface 500, according to an example embodiment. The user interface may be represented as a window (e.g. browser window) having an avatar appearance and an input field for alphanumeric inputs. Those skilled in the art would understand that many possible implementations of the user interface could be applied.

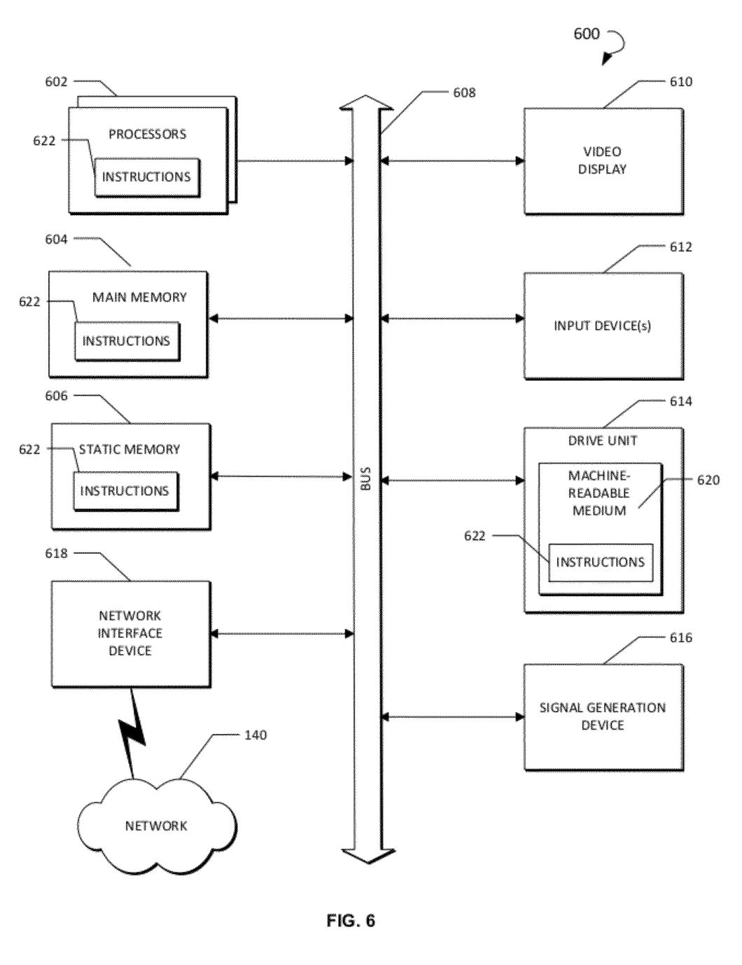

FIG. 6 shows a diagrammatic representation of a computing device for a machine in the example electronic form of a computer system 600, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 602 (e.g., a central processing unit (CPU), a graphics processing unit (GPU), or both), and a main memory 604 and a static memory 606, which communicate with each other via a bus 608. The computer system 600 can further include a video display unit 610 (e.g., a liquid crystal displays (LCD) or a cathode ray tube (CRT)). The computer system 600 also includes at least one input device 612, such as an alphanumeric input device (e.g., a keyboard), a cursor control device (e.g., a mouse), a microphone, and so forth. The computer system 600 also includes a disk drive unit 614, a signal generation device 616 (e.g., a speaker), and a network interface device 618.

The disk drive unit 614 includes a computer-readable medium 620 on which is stored one or more sets of instructions and data structures (e.g., instructions 622) embodying or utilized by any one or more of the methodologies or functions described herein. The instructions 606 and 622 can also reside, completely or at least partially, within the main memory 604 and/or within the engines 602 during execution thereof by the computer system 600. The main memory 604 and the engines 602 also constitute machine-readable media.

The instructions 622 can further be transmitted or received over a network 140 via the network interface device 618 utilizing any one of a number of well-known transfer protocols (e.g., Hyper Text Transfer Protocol (HTTP), CAN, Serial, and Modbus).

While the computer-readable medium 620 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAMs), read only memory (ROMs), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hyper text Markup Language (HTML), Dynamic HTML, Extensible Markup Language (XML), Extensible Stylesheet Language (XSL), Artificial Intelligent Markup Language (AILM), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, a method for the interactive delivering of website analytics data has been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What I claim is:

1. A computer-implemented method for interactive data delivery, the method comprising:
retrieving generic data associated with a request of a user;
generating a semantic model associated with the generic data and the user request;
processing the retrieved generic data to generate analytics data, the processing being based on the semantic model;
communicating the analytics data to a chatbot; and
converting, under control of the chatbot, the analytics data into a natural language format for delivering to the user.

2. The computer-implemented method of claim 1, further comprising:
receiving a command from the user to provide the analytics data in the natural language format; and
converting the command in the natural language format into one or more Application Programming Interface (API) calls, wherein the retrieving generic data is performed in response to the one or more API calls.

3. The computer-implemented method of claim 2, wherein the converting of the command in the natural language format comprises:
parsing the command in the natural language format;
determining an input-response dialogue pair; and
generating the one or more API calls associated with the input-response dialogue pair.

4. The computer-implemented method of claim 1, further comprising retrieving service data associated with the user in response to one or more API calls.

5. The computer-implemented method of claim 1, wherein the processing of the generic data comprises one or more of the following:
comparing the retrieved generic data to benchmark data;
segmenting the retrieved generic data;
evaluating metrics for the segments of the generic data; and
generating the analytics data.

6. The computer-implemented method of claim 1, wherein the processing further comprises applying rules of the semantic model against the generic data, the rules being associated with the user request.

7. The computer-implemented method of claim 6, wherein the processing of the generic data is associated with the one or more API calls.

8. The computer-implemented method of claim 7, further comprising merging the analytics data with a template response associated with the input-response dialogue pair.

9. The computer-implemented method of claim 1, further comprising delivering the analytics data in a natural language format to the user via a user interface.

10. The computer-implemented method of claim 9, wherein the analytics data to be delivered to the user is further provided with one or more of the following: text information, visual information, and a link to an external source.

11. The computer-implemented method of claim 10, wherein the command of the user is provided in a natural language format is text input or voice input.

12. A system for interactive data delivery, the system comprising one or more processors, the one or more subsystems comprising:
at least one subsystem to retrieve generic data associated with a request of a user;
at least one subsystem to generate a semantic model associated with the generic data and the user request;
at least one subsystem to process the retrieved generic data to generate analytics data, the processing is based on the semantic model;
at least one subsystem to communicate the analytics data to a chatbot; and
at least one subsystem to convert, under control of the chatbot, the analytics data into a natural language format for delivering to the user; and
a memory coupled to the one or more processors to store computer-executable instructions.

13. The system of claim 12, wherein the one or more processors are further configured to:
receive a command from the user for providing the analytics data in a natural language format; and
convert the command in the natural language format into one or more Application Programming Interface (API) calls, wherein the one or more processors retrieve generic data in response to the one or more API calls.

14. The system of claim 13, wherein the one or more processors are configured to convert the command in the natural language format implement:
parsing the command in the natural language format;
determining an input-response dialogue pair; and
generating the one or more API calls associated with the input-response dialogue pair.

15. The system of claim 14, wherein the one or more processors are further configured to retrieve service data associated with the user in response to the one or more API calls.

16. The system of claim 14, wherein the one or more processors are configured to process the generic data based on the one or more API calls.

17. The system of claim 14, wherein the one or more processors further configured to merge the analytics data with a template response associated with the input-response dialogue pair.

18. The system of claim 12, wherein the one or more processors are further configured to deliver the analytics data in the natural language format to the user via a user interface.

19. The system of claim 12, wherein the one or more processors are configured to process the generic data by applying rules of the semantic model against the generic data, the rules are associated with the user request.

20. A computer-readable medium comprising instructions, which when executed by one or more computers, perform the following operations:
retrieve generic data associated with a request of a user;
generate a semantic model associated with the generic data and the user request;
process the retrieved generic data to generate analytics data, the processing is based on the semantic model;
communicate the analytics data to a chatbot; and
convert, under control of the chatbot, the analytics data into a natural language format for delivering to the user.
